(19) United States
(12) Patent Application Publication
(10) Pub. No.: US 2025/0335887 A1
(43) Pub. Date: Oct. 30, 2025

(54) METHOD AND SYSTEM WITH AGGREGATE DATA PROCESSING

(71) Applicant: Visa International Service Association, San Francisco, CA (US)

(72) Inventors: Suraj Powar, San Jose, CA (US); Lacey Bartlett, San Mateo, CA (US); Archana Reddy Manchireddy, Fremont, CA (US); Melissa Diaz, Hayward, CA (US); Kelsey Nash, Brooklyn, NY (US); Claire Shapiro, San Francisco, CA (US); Somoshree Banerjee, Dublin, CA (US)

(73) Assignee: Visa International Service Association, San Francisco, CA (US)

(21) Appl. No.: 19/191,992

(22) Filed: Apr. 28, 2025

Related U.S. Application Data
(60) Provisional application No. 63/640,417, filed on Apr. 30, 2024.

(51) Int. Cl. G06Q 20/10; G06Q 20/38

(52) U.S. Cl. CPC G06Q 20/108; G06Q 20/386

(57) ABSTRACT

A method is disclosed. The method includes receiving, by a processing system, an enrollment message from a user device operated by a user via an authorizing entity computer. The enrollment message specifies one or more preferences associated with value portions associated with interactions conducted by the user. The method also includes receiving authorization request messages associated with a plurality of interactions conducted by the user, aggregating value portions associated with the authorization request messages to form an aggregate value; and processing a transfer of the aggregate value to one or more records associated with one or more receiving entities.

### CROSS-REFERENCES TO RELATED APPLICATIONS

This application is a non-provisional application of U.S. Provisional Application No. 63/640,417, filed on Apr. 30, 2024, which is herein incorporated by reference in its entirety for all purposes.

### BACKGROUND

Improved systems and methods for transferring data are needed. Some current methods allow users to select a portion value that is associated with an interaction amount in authorization request message. The selected portion value can be transferred to a receiving entity such as charity. The authorization request message may be a request to authorize an interaction such as a transaction between a user and a resource provider in which the user attempts to obtain a resource (e.g., a good, service, access to a secure location, access to secure data, etc.) from the resource provider. In such methods, the user would be presented with an option to provide the portion value when initiating the authorization request message at a resource provider computer operated by the resource provider. Eventually, the portion value would be transferred to the beneficiary.

Such systems are inefficient and consume significant computational resources. For example, in the above method, a system needs to process the portion value for every interaction that the user conducts with a resource provider. The user also needs to decide on the portion value for every interaction that the user conducts with a resource provider. If the user conducts interactions with hundreds of resource providers, then this will result in hundreds of messages. If there are thousands or millions of users, then the computational burden significantly increases.

Embodiments of the invention address these and other problems, individually and collectively.

### BRIEF SUMMARY

One embodiment of the invention includes a method comprising: receiving, by a processing system, an enrollment message from a user device operated by a user via an authorizing entity computer, the enrollment message specifying one or more preferences associated with value portions associated with interactions conducted by the user; receiving, by the processing system, authorization request messages associated with a plurality of interactions conducted by the user; aggregating, by the processing system, value portions associated with the authorization request messages to form an aggregate value; and processing, by the processing system, a transfer of the aggregate value to one or more records associated with one or more receiving entities.

Another embodiments of the invention includes a processing system comprising: a processor; and a non-transitory computer readable medium comprising code, executable by the processor, for performing a method comprising: receiving an enrollment message from a user device operated by a user via an authorizing entity computer, the enrollment message specifying one or more preferences associated with value portions associated with interactions conducted by the user; receiving authorization request messages associated with a plurality of interactions; aggregating value portions associated with the authorization request messages to form an aggregate value; and processing a transfer of the aggregate value to one or more receiving entities.

Another embodiments of the invention includes a method comprising: receiving, by an authorizing entity computer from a user device, an enrollment message; transmitting, by the authorizing entity computer to a processing system via an API, the enrollment message; receiving, by the authorizing entity computer, a plurality of authorization request messages associated with a plurality of interactions conducted by the user; receiving, by the authorizing entity computer, a pull interaction message comprising an aggregate value derived from aggregating value portions associated with the authorization request messages; and facilitating, by the authorizing entity computer, a transfer of the aggregate value to one or more records associated with one or more receiving entities.

Another embodiment of the invention includes an authorizing entity computer comprising a processor and a computer readable medium. The computer readable medium comprises code, executable by the processor, for performing a method comprising: receiving, by an authorizing entity computer from a user device, an enrollment message; transmitting, by the authorizing entity computer to a processing system via an API, the enrollment message; receiving, by the authorizing entity computer, a plurality of authorization request messages associated with a plurality of interactions conducted by the user; receiving, by the authorizing entity computer, a pull interaction message comprising an aggregate value derived from aggregating value portions associated with the authorization request messages; and facilitating, by the authorizing entity computer, a transfer of the aggregate value to one or more records associated with one or more receiving entities.

These and other embodiments of the invention are described in further detail below.

### BRIEF DESCRIPTION OF THE DRAWINGS

FIG. 1 shows a system and a process flow illustrating embodiments of the invention.

FIGS. 2A-2C show screenshots of user interfaces according to embodiments.

FIG. 3 shows a transaction system that can be used in embodiments of the invention.

FIG. 4 shows a block diagram of an authorization entity computer according to embodiments.

FIG. 5 shows a block diagram of a processing system according to embodiments.

FIG. 6 shows a block diagram of a user device according to an embodiment.

### DETAILED DESCRIPTION

Prior to discussing embodiments of the invention, some terms can be described in further detail.

A “user” may include an individual. In some embodiments, a user may be associated with one or more personal accounts and/or mobile devices. The user may also be referred to as a cardholder, account holder, or consumer.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as watches, earpieces, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “portable device” may comprise a device that is portable. An example of a portable device is a payment device.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near the surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices, etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction can include a transaction interaction, a data transfer interaction, an access interaction, etc.

An “interaction request message” may be an electronic message that requests authorization for an interaction. In some embodiments, it is sent to a gateway computer and/or an authorizing entity computer associated with a portable device to request authorization for an interaction involving the portable device. The interaction request message may be a pull interaction message or a push interaction message. The interaction request message may include an authorizing entity account identifier that may be associated with a portable device or account. An interaction request message may also comprise interaction information associated with a current interaction, such as a value for the interaction, and a credential. An interaction request message according to some embodiments may be an authorization request message.

“Interaction data” can include data related to and/or recorded during an interaction. In some embodiments, interaction data can include an amount, a date, a time, one or more user identifiers, credentials, and/or additional data relating to an interaction between a sender user and receiver user.

An “interaction response message” may be a message that responds to an interaction request. In some cases, it may be an electronic message reply to an interaction request message. The interaction response message may include, by way of example only, one or more of the following status indicators: Approval—interaction was approved; Decline—interaction was not approved.

An “interaction application” may be code or other data stored on a computer readable medium (e.g., memory element or secure element) that may be executable by a processor to initiate an interaction.

A “pull interaction message” may be an interaction request message seeking that a value of a current interaction be debited from an account. The pull interaction message can comprise one or more indicators that enable an authorizing entity to make an authorization decision regarding the account that it manages. In embodiments, the pull interaction message may be used to debit the value for the interaction from an account associated with the sender and can comprise a sender credential and the value for the interaction. An example of a pull transaction message can include an AFT message.

An AFT (Account Funding Transaction) is a transaction designed to supply funds to another account such as a credit, prepaid, debit, ATM or online account. In some cases, an AFT is paying the service provider bank for sending funds to the recipient and results in a debit to the sender's card account.

A “push interaction message” may be an interaction request message seeking that a value of a current interaction be credited to an account. The push interaction message can comprise one or more indicators that enable an authorizing entity to deliver a value for the interaction to a recipient account that it manages. The transmission of a push interaction message may be separate from and can take place after the transmission of a pull interaction message. An example of a push transaction message can be a credit transaction message such as an OCT message.

A “credit transaction message” may include a message that initiates a credit to an account. In some embodiments, the credit transaction message may be an Original Credit Transaction (OCT) message. An OCT (Original Credit Transaction) is typically a clearing and settlement credit transaction designed for use in business applications such as a business money transfer or business-to-consumer repayments. When used in embodiments of the present invention, the OCT transaction can be used to deliver funds to the target account. In some cases, it is separate from, and in some cases, can take place after, an AFT transaction.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue account credentials stored on a user device, such as a cellular telephone, smart card, tablet, or laptop to the user.

A “computing device” may include any suitable device that can electronically process data. Examples of computing devices include desktop computers, mobile devices or mobile computing devices, television sets, etc.

A “server computer” may include a powerful computer or cluster of computers. For example, the server computer can be a large mainframe, a minicomputer cluster, or a group of servers functioning as a unit. In one example, the server computer may be a database server coupled to a Web server.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is understood to be a static verification value associated with a payment device. CVV2 values are visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided to make payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle, or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

An “authorization request message” may be a message that requests permission to conduct an interaction. For example, an authorization request message may include an electronic message that is sent to a payment processing network (e.g., an example of a processing system) and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “application” may be computer code or other data stored on a computer readable medium (e.g., memory element or secure element) that may be executable by a processor to complete a task.

One embodiment of the invention includes a method comprising receiving, by a processing system, an enrollment message from a user device operated by a user via an authorizing entity computer. The enrollment message includes one or more preferences associated with value portions associated with interactions conducted by the user. A value portion can be an amount that the user wishes to donate to one or more charities for a transaction (e.g., payment transaction). A value portion may be associated with an authorization request message. For example, a preference for a value portion may be to “round up” to the nearest dollar for every payment transaction conducted by the user using a credit or debit card. Another preference for a value portion may be to give one dollar for every payment transaction conducted by the user using the credit or debit card. The method further comprises receiving, by the processing system, authorization request messages associated with a plurality of interactions (e.g., payment transactions). The processing system then aggregates the value portions for the transactions (within a predetermined time window such as one month) to form an aggregate value. The method then may include processing, by the processing system, a transfer of the aggregate value to a receiving entity such as a charity. The transfer to the charity can occur via a service provider associated with the charity.

As an illustration, a user may have conducted four credit card transactions for 3.50, 10.50, 8.50, and 98.50 (dollars) within a one-month window. The user may have specified that the amounts may be rounded up to the nearest dollar, and those amounts may be donated to the user's preferred charity (e.g., an example of a receiving entity). In this example, the aggregate value would be 2.00 (e.g., 0.50+0.5+0.5+0.5). The aggregate value of 2.00 would be automatically transferred from a record (e.g., an account) of the user to a record associated with the preferred charity at the conclusion of the one-month window.

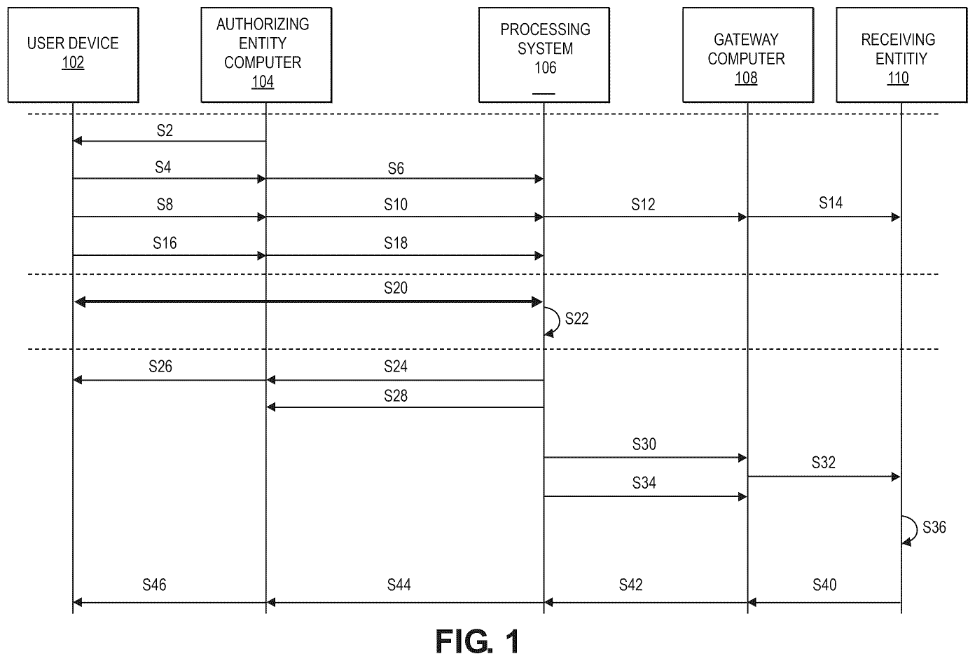

FIG. 1 shows a system and a process flow according to embodiments. FIG. 1 shows a user (e.g., a cardholder) that can operate a user device 102. The user device 102 can be in communication with an authorizing entity computer 104 operated by an authorizing entity (e.g., an issuer). The user device 102 can communicate with the authorizing entity computer 104 via an authorizing entity application (e.g., an issuer application) that includes an SDK (software development kit), which can be alternatively referred to as a “widget.” The authorizing entity computer 104 can be in communication with a processing system 106. The processing system 106 can have several modules including a consent management module, an incentive (e.g., offers) module, an authorization processing module, a clearing and settlement module, and a push/pull transfer module (e.g., Visa Direct™). The processing system can include a payment processing network. FIG. 1 also shows a gateway computer 108, which can be a connection point between the processing system and receiving entities 110. Although one gateway computer 108 is shown, there can be many gateway computers in communication with the processing system 106.

The receiving entities 110 can be beneficiaries that will receive push transfer values associated with the portion amounts. In some embodiments, a receiving entity can be a charity. In another embodiment, the receiving entity can be an organization that performs management for several different charities.

The gateway computer 108 can work in association with the receiving entities 110. In some embodiments, the gateway computer 108 can be a computer that is operated by a financial institution such as an issuing bank or an acquiring bank. The gateway computer 108 can have records (e.g., accounts) associated with the receiving entities 110.

Prior to step S2, a user may be interacting with an interaction application on the user device 102. The interaction application may be an application such as an issuer application, a banking application, a digital wallet application, or any other suitable application that can be used to process or initiate the processing of interactions. The interaction application may provide an option for the user to select different receiving entities that can receive portion values associated with interactions (e.g., payment transactions) conducted by the user. The interaction application can be managed by the authorizing entity computer 104 and can have an SDK that is managed by and is in communication with the processing system 106.

Also, prior to step S2, the various receiving entities 110 and the gateway computer 108 may have registered with the processing system 106. The receiving entities 110 may have provided information about the programs (e.g., charity programs) that are run by the receiving entities 110 to the processing system 106. The receiving entities 110 may have also provided to the processing system 106, credentials (e.g., primary account numbers) associated with records (e.g., accounts) that will be credited with multiple value portions or aggregate values associated with transactions conducted by users.

In step S2, after the user device 102 contacts the authorizing entity computer 104. The authorizing entity computer 104 presents an option to allow the user to provide value portions to receiving entities when the user conducts interactions with portable devices issued by the authorizing entity operating the authorizing entity computer 104. The receiving entities may be charities or may be charity service providers and may be associated with programs such as donation programs.

In step S4, the user can provide consent to review available donation programs, and/or provide other consent to use or store their personal information.

In step S6, a save consent message can be sent from the authorizing entity computer 104 to a consent management module of the processing system 106 via a save consent API (application programming interface) to store the user's consent.

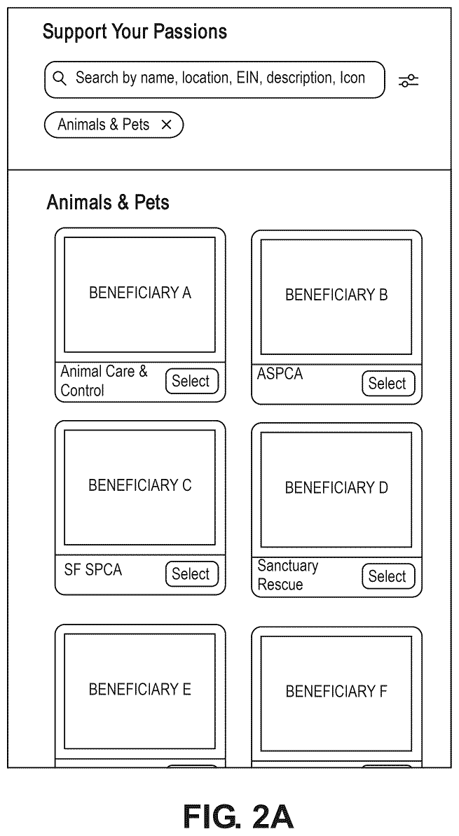

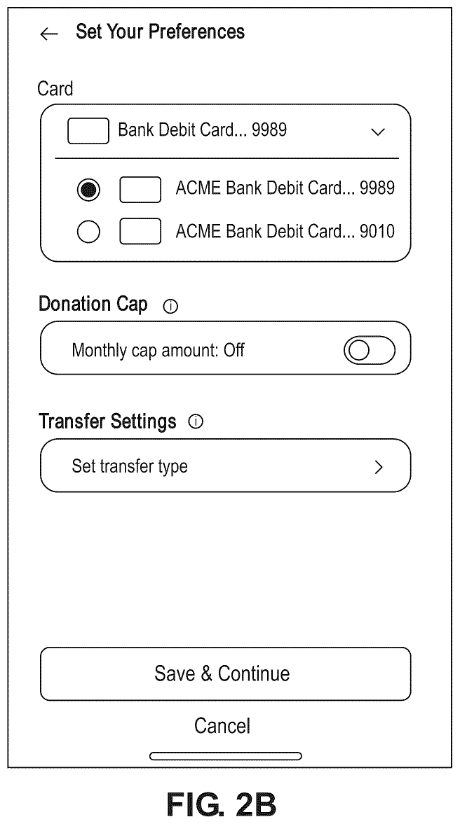

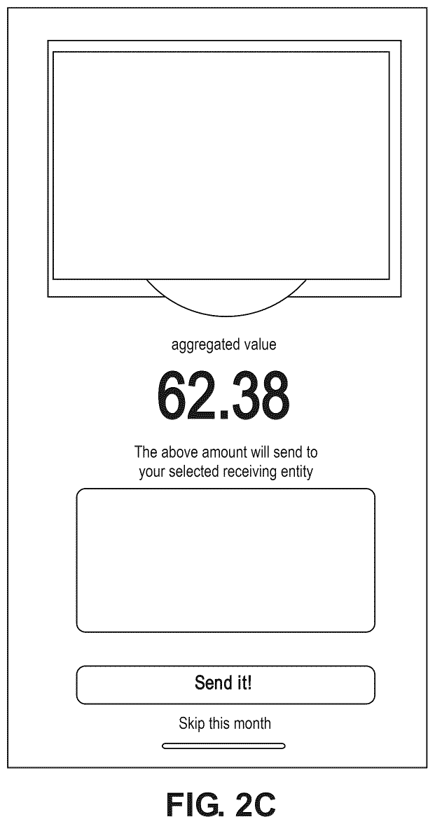

In steps S8 and S10, the user using the user device 120 can browse information on available charities to which donations can be made. A charity search API may be used. FIG. 2A shows an example of a user interface 202 that the user might see in a display of the user device 102. Using the user device 102 and the SDK, the user may select a program from several programs (e.g., donation programs) associated with recipient entities (e.g., charities). The user may desire that the recipient entity associated with the selected program receive value portions associated with the user's interactions.

If the user is searching for a specific receiving entity (e.g., a charity to which to donate), and information about that receiving entity is not pre-stored at the processing system 106, then information about the specific receiving entity can be obtained from the receiving entity directly, or via the gateway computer 108 In steps S12 and S14.

In steps S16 and S18, the user, using the user device 102, can transmit an enrollment message to the processing system 106 via the authorizing entity computer 104, and the processing system 106 can receive the same. The enrollment message can include one or more preferences associated with value portions associated with interactions conducted by the user. For example, the user can use the user device 102 to select a portable device such as a payment card that will be used to conduct interactions (e.g., transactions) in which value portions associated with the interactions will be provided to the one or more receiving entities 110 selected by the user. The processing system 106 can register the credential (e.g., a PAN) associated with the selected portable device via an enrollment API. For example, the interactions can be payment transactions, and the portable device may be a payment card. The payment transactions conducted with the payment card will be tied to charitable donations to the one or more charities selected by the user.

In step S16, the user can also provide, using the user device 102, selections of receiving entities 110 to the processing system 106 via the authorizing entity computer 104. The user can also provide, using the user device 102, value portion settings (e.g., donation settings) to the processing system 106 via the authorizing entity computer 104. The user may indicate in the value portion settings how often and much value portion aggregation will take place on behalf of the user. These settings may be stored at the processing system 106. An example user interface in FIG. 2B shows controls for the user to select a specific portable device (e.g., a particular debit or credit card) to use with the method, a frequency or limit of value portion aggregation, and an automatic or manual authorization of the transfer of one or more aggregate value to the one or more receiving entities (e.g., the “set transfer type” button).

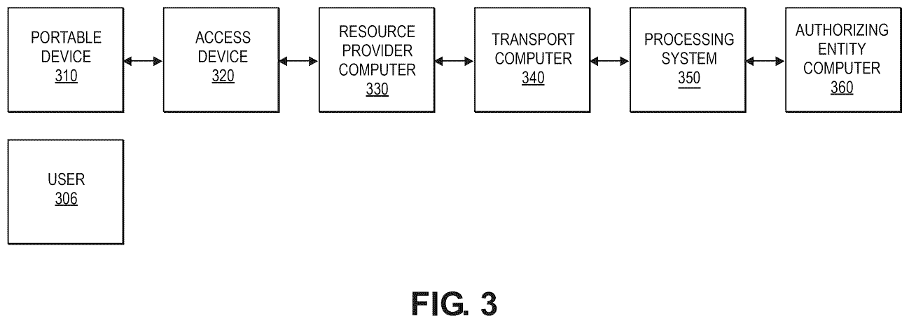

In step S20, a plurality of transactions can be conducted using the selected portable device (e.g., credit card). In these transactions, the processing system 106 can receive and transmit a plurality of authorization request messages and receive and transmit a plurality of authorization response messages for a plurality of interactions. Exemplary details of the processing of such interactions are described below with respect to FIG. 3.

In step S22, the processing system 106 can keep a ledger of the value portions (e.g., donation amounts) for each interaction for the portable device selected by the user and can aggregate value portions associated with interactions conducted by the user using the selected portable device. A running total of the value portions during a time period for an account can also be calculated on the virtual ledger managed by the processing system 106. In some embodiments, the virtual ledger can be shared with the authorizing entity computer 104, such that the authorizing entity computer 104 could place a hold on the record (e.g., account) of the user for the value portions that the user has committed to giving to the one or more receiving entities 110. Alternatively, the user's account can be debited for the value portions, and the user may be asked to pay for the agreed upon value portions before any aggregate value portions are sent to the intended one or more receiving entities. For example, a user may conduct a 5.50 dollar (an example of an interaction value) transaction with a resource provider using a particular credit card that was enrolled with the processing system 106. The user may have committed to rounding up any transactions conducted with the credit card to the nearest dollar to a charity such as a local animal shelter. The user may have agreed to automatically donate 0.50 dollars (an example of a value portion) to round the purchase amount to 6.00 dollars (an example of a target value). At the end of the month, the user be presented with a statement showing the 5.50 purchase at the resource provider and the round up value of 0.5 dollars that is associated with the purchase. In some embodiments, this 0.5 dollar round up amount may be held at the authorizing entity computer until it is aggregated with other round up values to create an aggregate value. The aggregate value is then transferred and credited to an account associated with the local animal shelter.

In steps S24 and S26, upon the end of the time window (or period) for aggregation, the processing system 106 can transmit an event notification (e.g., a donate event notification) to the user device 102 via the authorizing entity computer 104. The user can confirm, skip, or edit the proposed transfer of the aggregate value to the one or more receiving entities (e.g., donation(s)) if the user's input is requested. An example of a user interface that allows the user to make these decisions is shown in FIG. 2C. In some embodiments, the transfer of the aggregate value to the one or more receiving entities occurs automatically without the user's input. The processing system 106 can then process a transfer of the aggregate value to one or more records associated with one or more receiving entities 110.

In step 28, the processing system 106 can generate and transmit a pull interaction message comprising the primary account number of the portable device and the aggregate value to the authorizing entity computer 104. The pull interaction message may comprise at least the credential (e.g., a PAN) associated portable device previously selected by the user, and the aggregate value. The pull interaction message can be an AFT (account funding transaction) message. After receiving the pull interaction message, the authorizing entity computer 104 can immediately debit the record associated with the credential of the user.

In step S30, the processing system 106 sends a notification with transaction details to the gateway computer 108. The transaction details can include information the pull interaction message has been transmitted. The transaction details can also include details including the amount of the aggregate value, the user's information, the one or more receiving entities that are intended to receive the aggregate value or portions thereof, and optionally, the value portions that make up the aggregate value.

In step S32, gateway computer 108 may provide the transaction details to the one or more receiving entities 110. Note that steps S30 and S32 can occur before or after step S34.

In step S34, after the pull interaction message is transmitted to the authorizing entity computer 104 in step S28, the processing system 106 generates a push interaction message to the gateway computer 108 comprising a record identifier (e.g., a PAN or primary account number) associated with the one or more receiving entities 110 and the aggregate value. The push interaction message can be an OCT (original credit transaction) message. It then transmits the push interaction message to the gateway computer 108. Once received, the gateway computer 108 can immediately credit the record associated with the one or more receiving entities 110.

In step S36, if the receiving entity of the one or more receiving entities 110 receiving the aggregate amount is an organization that works with multiple charities, then the receiving entity can use the transaction details received in step S32, and can distribute any funds associated with the aggregate value to those charities.

In steps S40, S42, S44, and S46, confirmations that the one or more receiving entities received the aggregate value can be sent to the user via the processing system 106, the authorizing entity computer 104, and the user device 102.

After step S34, the transfer of actual funds from the authorizing entity to the record of the one or more receiving entities 110 can occur via the processing system 106 in a settlement process. The authorizing entity computer 104 can facilitate this transfer in conjunction with other entities.

FIG. 3 shows a block diagram of a system that can be used to conduct interactions such as this described in step S20 in FIG. 1. FIG. 3 shows a user 306 that can operate a portable device 310. The user 306 may use the portable device 310 to pay for a good or service at a merchant. The merchant may operate a resource provider computer 330 and/or an access device 320. The merchant may communicate with an authorizing entity computer 360 via a transport computer 340 and a processing system 350.

The processing system 350 may include data processing subsystems, networks, and operations used to support and deliver authorization services, exception file services, and clearing and settlement services. An exemplary processing system may include VisaNet™. Processing systems such as VisaNet™ can process credit card transactions, debit card transactions, and other types of commercial transactions. VisaNet™ includes a VIP system (Visa Integrated Payments system) which processes authorization requests and a Base II system which performs clearing and settlement services. The processing system may use any suitable wired or wireless network, including the Internet.

A typical payment transaction flow using a portable device 310 at an access device 320 (e.g., POS location) can be described as follows. A user 306 presents his or her portable device 310 (e.g., a payment card, mobile phone, etc.) to an access device 320 to pay for an item or service. The portable device 310 and the access device 320 interact such that access data from the portable device 310 (e.g., PAN, a payment token, verification value(s), expiration date, etc.) is received by the access device 320 (e.g., via contact or contactless interface). The resource provider computer 330 may then receive this information from the access device 320 via an external communication interface. The resource provider computer 330 may then generate an authorization request message that includes the information received from the access device 320 (i.e., information corresponding to the portable device 310) along with additional transaction information (e.g., a transaction amount, merchant specific information, etc.) and electronically transmits this information to an transport computer 34. The transport computer 340 may then receive, process, and forward the authorization request message to a processing system 350 for authorization.

In general, prior to the occurrence of a credit or debit-card transaction, the processing system 350 has an established protocol with each issuer on how the issuer's transactions are to be authorized. In some cases, such as when the transaction amount is below a threshold value, the processing system 350 may be configured to authorize the transaction based on information that it has about the user's account without generating and transmitting an authorization request message to the authorizing entity computer 360. In other cases, such as when the transaction amount is above a threshold value, the processing system 350 may receive the authorization request message, determine the issuer associated with the portable device 310, and forward the authorization request message for the transaction to the authorizing entity computer 360 for verification and authorization. Once the transaction is authorized, the authorizing entity computer 360 may generate an authorization response message (that may include an authorization code indicating the transaction is approved or declined) and transmit this electronic message via its external communication interface to processing system 350. The processing system 350 may then forward the authorization response message to the transport computer 340, which in turn may then transmit the electronic message to comprising the authorization indication to the resource provider computer 330, and then to the access device 320.

At the end of the day or at some other suitable time interval, a clearing and settlement process between the resource provider computer 330, the transport computer 340, the processing system 350, and the authorizing entity computer 360 may be performed on the transaction.

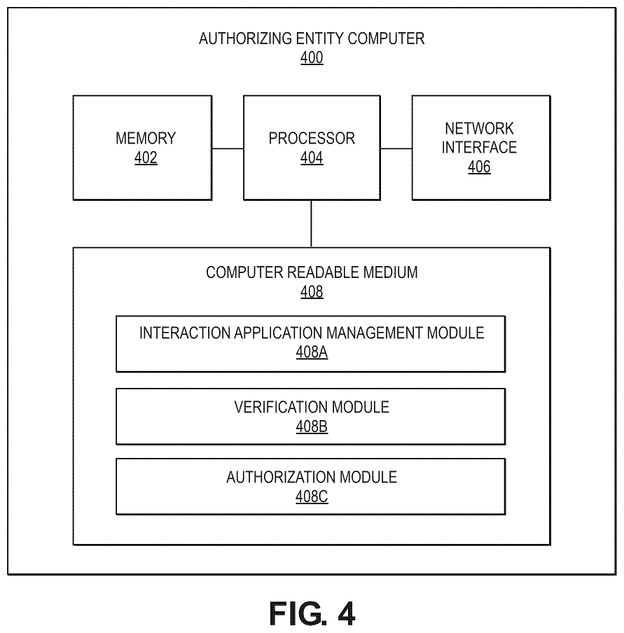

FIG. 4 shows a block diagram of an authorizing entity computer 400 according to embodiments. The exemplary authorizing entity computer 400 may comprise a processor 404. The processor 404 may be coupled to a memory 402, a network interface 406, and a computer readable medium 408. The computer readable medium 408 can comprise an interaction application management module 408A, a verification module 408B, and an authorization module 408C.

The memory 402 can be used to store data and code and may be like the memory 402 as described herein. For example, the memory 402 can store user accounts maintained on behalf of users of user devices.

The interaction application management module 308A may comprise code or software, executable by the processor 304, for managing an interaction application on a user device. The management of the interaction application can include processing transactions initiated by the interaction application, updating the interaction application, and otherwise supporting the interaction application.

The verification module 308B may comprise code or software, executable by the processor 304, for verifying data. The verification module 308B, in conjunction with the processor 304, can verify data during an interaction, and verify and adjust balances of records (e.g., accounts) managed by the authorizing entity computer.

The authorization module 308C may comprise code or software, executable by the processor 304, for authorizing or declining an interaction. It can, in conjunction with the processor 304, aid in receiving, modifying, and sending authorization request messages and authorization response messages.

The computer readable medium 308 may comprise code, executable by the processor 304, for performing a method comprising: receiving, by an authorizing entity computer from a user device, an enrollment message; transmitting, to a processing system via an API, the enrollment message; receiving a plurality of authorization request messages associated with a plurality of interactions conducted by the user; receiving a pull interaction message comprising an aggregate value derived from aggregating value portions associated with the authorization request messages; and facilitating a transfer of the aggregate value to one or more records associated with one or more receiving entities.

The network interface 406 may include an interface that can allow the authorizing entity computer 400 to communicate with external computers. The network interface 406 may enable the authorizing entity computer 400 to communicate data to and from another device such as an aggregation entity computer, a server computer, a transport computer, an authorizing entity computer, etc. Some examples of the network interface 406 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 406 may include Wi-Fi™. Data transferred via the network interface 406 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 406 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

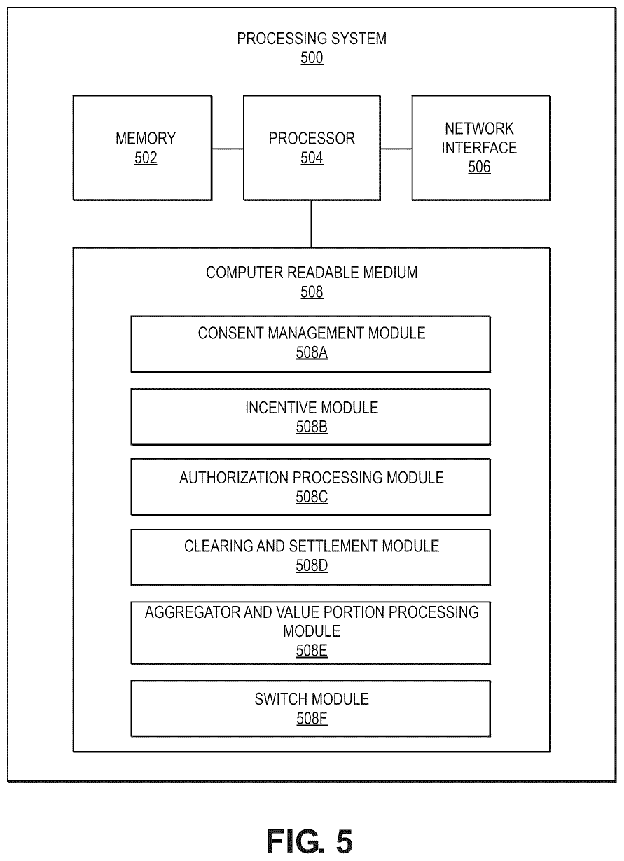

FIG. 5 shows a block diagram of a processing system 500 according to embodiments. The exemplary processing system 500 may comprise a processor 504. The processor 504 may be coupled to a memory 502, a network interface 506, and a computer readable medium 508. The computer readable medium 508 can comprise a consent management module 508A, an incentive module 508B, an authorization processing module 508C, a clearing and settlement module 508D, an aggregator and value portion processing module 508E, and a switch module 508F.

The memory 502 can be used to store data and code and may be like the memory 502 as described herein. For example, the memory 502 can store data regarding user preferences, data relating to users and receiving entities, etc.

The computer readable medium 508 may comprise code, executable by the processor 504, for performing a method comprising: receiving an enrollment message from a user device operated by a user via an authorizing entity computer, the enrollment message specifying one or more preferences associated with value portions associated with interactions conducted by the user; receiving authorization request messages associated with a plurality of interactions; aggregating value portions associated with the authorization request messages to form an aggregate value; and processing a transfer of the aggregate value to one or more receiving entities.

The consent management module 508A may comprise code or software, executable by the processor 504, for obtaining consent from the user to participate in the above-described methods and saving the consent.

The incentive module 508B may comprise code or software, executable by the processor 504, for presenting and managing incentives such as offers to users.

The authorization processing module 508C may comprise code or software, executable by the processor 504, for authorizing or declining an interaction. It can, in conjunction with the processor 504, aid in receiving, modifying, and sending authorization request messages and authorization response messages. It can also generate and send push and pull interaction messages as described above.

The clearing and settlement module 508D may comprise code executable by the processor 504 for performing clearing and settlement processing.

The aggregator and value portion processing module 508E may comprise code executable by the processor 504 for aggregating value portions to form aggregate values, determining value portions based on data in interaction request messages, maintaining a virtual ledger with credentials and value portion aggregate totals, etc.

The switch module 508F can comprise code, executable by the processor 504 for allowing external users to switch the routing of transaction messages. For example, a user credential may initially be tied to send funds to an initial receiving entity such as a charity. The charity may then want an organization that manages multiple charities to manage its payment processing. In this case, an external user such as the charity may update rules in the switch module 508F so that any aggregate value transfers to the charity's bank account be changed so that they are transferred to the bank account of the organization.

The network interface 506 may be like the network interface 406 in FIG. 4 and will not be repeated here.

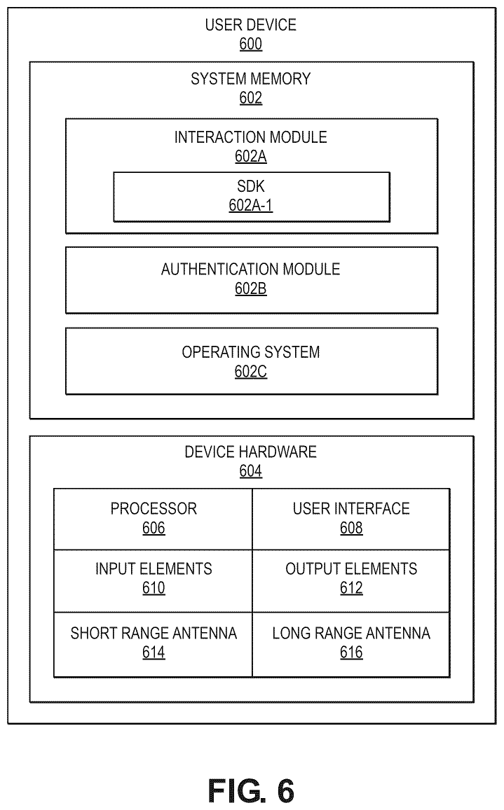

FIG. 6 illustrates a diagram of a user device 600 according to an embodiment. The user device 600 may include device hardware 604 coupled to a system memory 602.

Device hardware 604 may include a processor 606, a short-range antenna 614, a long-range antenna 616, input elements 610, a user interface 608, and output elements 612 (which may be part of the user interface 608). Examples of input elements may include microphones, keypads, touchscreens, sensors, etc. Examples of output elements may include speakers, display screens, and tactile devices. The processor 606 can be implemented as one or more integrated circuits (e.g., one or more single core or multicore microprocessors and/or microcontrollers), and is used to control the operation of user device 600. The processor 606 can execute a variety of programs in response to program code or computer-readable code stored in the system memory 602 and can maintain multiple concurrently executing programs or processes.

The long-range antenna 616 may include one or more RF transceivers and/or connectors that can be used by user device 600 to communicate with other devices and/or to connect with external networks. The long-range antenna 616 may be configured to communicate with a remote base station and a remote cellular or data network, over the air. The short-range antenna 609 may be configured to communicate with external entities through a short-range communication medium. The short-range antenna 609 may comprise a contactless interface that can interact with a contactless interface of another device (e.g., a portable device). Examples of a contactless interface may include one or more radio frequency (RF) transceivers that can send and receive communications using near-field communications (NFC), or other radio frequency or wireless communication protocols. The user interface 608 can include any combination of input and output elements to allow a user to interact with and invoke the functionalities of the user device 600.

The system memory 602 can be implemented using any combination of any number of non-volatile memories (e.g., flash memory) and volatile memories (e.g., DRAM, SRAM), or any other non-transitory storage medium, or a combination thereof media. The system memory 602 may store computer code, executable by the processor 606, for performing any of the functions described herein.

The system memory 602 may also store an interaction application 602A comprising an SDK 602A-1, an authentication module 602B, and an operating system 602C. The functions of the interaction application 602A and the SDK 602A-1 are described above. The authentication module 602B may comprise code, executable by the processor 606, to authenticate a user. This can be performed using user secrets (e.g., passwords) or user biometrics.

Embodiments have several advantages. Embodiments of the invention can aggregate value portions such that fewer messages are transmitted than similar systems that process and transmit messages with value portions for every interaction. As such, embodiments of the invention reduce the number of computational resources compared to conventional systems and are also more convenient for users.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a processing system, an enrollment message from a user device operated by a user via an authorizing entity computer, the enrollment message specifying one or more preferences associated with value portions associated with interactions conducted by the user;
receiving, by the processing system, authorization request messages associated with a plurality of interactions conducted by the user;
aggregating, by the processing system, value portions associated with the authorization request messages to form an aggregate value; and
processing, by the processing system, a transfer of the aggregate value to one or more records associated with one or more receiving entities.

2. The method of claim 1, wherein the plurality of interactions occur within a predetermined time window.

3. The method of claim 1, wherein the processing of the transfer of the aggregate value comprises transmitting a pull interaction message comprising the aggregate value to the authorizing entity computer and transmitting a push interaction message comprising the aggregate value to a gateway computer.

4. The method of claim 1, wherein the one or more receiving entities includes a beneficiary.

5. The method of claim 1, wherein the authorizing entity computer is operated by an issuer.

6. The method of claim 1, wherein the processing system and the authorizing entity computer communicate via one or more APIs.

7. The method of claim 1, wherein the authorization request messages have interaction values and the value portions are determined using subtracting the interactions values from target values.

8. The method of claim 7, wherein the target values are determined using the one or more preferences.

9. The method of claim 1, wherein the processing the transfer of the aggregate value comprises transmitting a pull interaction message comprising the aggregate value to the authorizing entity computer and transmitting a push interaction message comprising the aggregate value to a switch, wherein the switch transfers the aggregate value or a portion of the aggregate value to the one or more records associated with the one or more receiving entities.

10. The method of claim 9, wherein the push interaction message is an OCT message.

11. A processing system comprising:
a processor; and
a non-transitory computer readable medium comprising code, executable by the processor, for performing a method comprising:
receiving an enrollment message from a user device operated by a user via an authorizing entity computer, the enrollment message specifying one or more preferences associated with value portions associated with interactions conducted by the user;
receiving authorization request messages associated with a plurality of interactions;
aggregating value portions associated with the authorization request messages to form an aggregate value; and
processing a transfer of the aggregate value to one or more receiving entities.

12. The processing system of claim 11, wherein the processing the transfer of the aggregate value comprises transmitting a pull interaction message comprising the aggregate value to the authorizing entity computer and transmitting a push interaction message comprising the aggregate value to a switch, wherein the switch transfers the aggregate value or a portion of the aggregate value to one or more records associated with the receiving entities.

13. The processing system of claim 11, wherein the plurality of interactions occur within a predetermined time.

14. The processing system of claim 11, wherein the authorization request messages have interaction values and the value portions are determined using subtracting the interactions values from target values.

15. The processing system of claim 14, wherein the target values are determined using the one or more preferences.

16. A method comprising:
receiving, by an authorizing entity computer from a user device operated by a user, an enrollment message;
transmitting, by the authorizing entity computer to a processing system via an API, the enrollment message;
receiving, by the authorizing entity computer, a plurality of authorization request messages associated with a plurality of interactions conducted by the user;
receiving, by the authorizing entity computer, a pull interaction message comprising an aggregate value derived from aggregating value portions associated with the authorization request messages; and
facilitating, by the authorizing entity computer, a transfer of the aggregate value to one or more records associated with one or more receiving entities.

17. The method of claim 16, wherein the pull interaction message is an AFT message.

18. The method of claim 16, wherein the plurality of interactions occur within a predetermined time.

19. The method of claim 16, wherein the authorization request messages have interaction values and the value portions are determined using subtracting the interactions values from target values.

20. The method of claim 16, wherein the user device is a mobile phone.
